(19) United States
(12) Patent Application Publication
(10) Pub. No.: US 2012/0047421 A1
(43) Pub. Date: Feb. 23, 2012

(54) SYSTEM AND METHOD FOR CREATING AND DISPLAYING A TIMELINE PRESENTATION

(75) Inventor: James Holman, Tacoma, WA (US)

(73) Assignee: Holman Enterprises, LLC, Tacoma, WA (US)

(21) Appl. No.: 13/048,811

(22) Filed: Mar. 15, 2011

Related U.S. Application Data
(60) Provisional application No. 61/314,067, filed on Mar. 15, 2010.

(51) Int. Cl. G06F 17/00

(52) U.S. Cl. 715/202; 715/273

(57) ABSTRACT

A system and method for creating and displaying a timeline presentation. A timeline presentation enables a presenter to provide a dynamic and animated display of a timeline and associated information. Events may be added to a timeline by providing information about an event (e.g., date, time, and description) and associating the event with the timeline. Events may be associated with a multimedia file and visually represented using a variety of treatments. Events may be associated with an absolute point in time, a period of time, or a time relative to another event. A timeline may also include annotations, which provide information that may not necessarily be associated with a particular event. A timeline presentation dynamically displays events, annotations, and nested timelines in a pre-determined sequence. The disclosed system also allows a presenter to markup a timeline presentation to draw a viewer's attention to certain features of the timeline.

### CROSS-REFERENCE TO RELATED APPLICATION(S)

This application claims the benefit of U.S. Provisional Application No. 61/314,067, filed Mar. 15, 2010, entitled “SYSTEM AND METHOD FOR CREATING AND DISPLAYING A TIMELINE PRESENTATION,” which is incorporated herein by reference in its entirety.

### BACKGROUND

When making presentations to large groups, users are limited in the tools that they can use to create presentations. Any tool used for this purpose must be capable of displaying information in an attractive and clear format that can be easily understood by an audience. For presentations involving a large amount of data, this task can present significant challenges. One such challenge is overcoming information overload by the viewer, a phenomenon that may cause a viewer to stop absorbing critical information that is presented in a cluttered or visually unappealing way. This problem can be particularly severe when the information being conveyed relates to a series of events linked by a temporal relationship.

Several tactics are commonly employed in an attempt to overcome this problem. Among them are displaying information in large type, color coding information so that different categories of information may be more discernable and more easily absorbed by the user, or by presenting information in a bullet point format that enables users to more readily appreciate the hierarchical relationships among the informational items being conveyed. While these tactics can be very helpful to convey large amounts of information, they are unable to present information in a way that is visually streamlined and uncluttered, and therefore more likely to be absorbed usefully by the viewer.

### BRIEF DESCRIPTION OF THE DRAWINGS

FIG. 1 is a block diagram of a system that allows a user to create and display a timeline presentation.

FIG. 2 is a display of a representative timeline for which the disclosed system may generate a timeline presentation.

FIG. 3 is a display showing the presentation of a single timeline element.

FIGS. 4A-4C are displays of a timeline spanning multiple screens.

FIG. 5 is a timeline that has been marked up by a presenter during the course of a timeline presentation.

FIGS. 6A-6D show representative dialog box tabs used to customize a timeline presentation.

FIG. 7 is a flow chart of a process for receiving an event definition from a user and storing the event in association with a timeline for subsequent presentation to a viewer.

FIG. 8 is a flow chart of a process for retrieving stored event definitions that are associated with a timeline and displaying the events as part of a timeline presentation.

### DETAILED DESCRIPTION

A system and method for creating and displaying a timeline presentation is provided. A timeline is a visual representation of a series of events, allowing a viewer to better appreciate or comprehend the temporal relationships between events. A timeline presentation enables a user to provide a dynamic and animated display of a timeline and associated information. A timeline presentation could be useful, for example, in a classroom presentation, a business strategy meeting, a civic planning session, a construction overview, a jury, or to any other audience where a structured display of events would allow the audience to better visualize the chronology of events. A timeline presentation may be created, for example, to show the relationship of the planning process, permitting requirements, architectural or design decisions, and construction milestones that must be achieved for the development of a commercial office building. A timeline presentation may also be created, for example, to dynamically present the events associated with a personal injury action (e.g., the injury, doctor visits, physical therapy sessions, negotiations with insurance companies, and the filing of a complaint).

Using the disclosed system, a user can create and display a timeline presentation. A timeline is two or more events that are graphically presented in a manner that shows the relationship between events with respect to a particular time scale. An event may be added to a timeline by providing information about the event (e.g., date, time, and description) and associating the event with the timeline. An event may also be associated with a multimedia file, such as an audio clip, video clip, or document. Events may be visually represented in a variety of different treatments, such as a shape with associated text, an image, a video, etc. Events may be aligned either automatically or by the user in order to achieve a visual effect that is more pleasing to the viewer or more clearly conveys the information represented on the timeline. An event may be associated with an absolute point in time, a period of time, or a time relative to another event. Timelines may be nested to provide additional detail for a portion of a timeline. For example, a timeline spanning from Jan. 1, 1990 to Dec. 31, 2007 may include a period of time in which a large number of events occurred. Each of the events for a given period may be placed in a “nested timeline” and replaced on the timeline with a single identifier. Nested timelines are derived from a “parent timeline” and may display events at a different time scale than the time scale used by its parent timeline. A timeline may also include annotations, which provide information that may not necessarily be associated with a particular event. For example, an annotation might include text describing the timeline, such as “Timeline of Events” or might include an image. Further details about timelines and nested timelines may be found in the concurrently-filed U.S. patent application entitled “SYSTEM AND METHOD FOR NESTING TIMELINES,” attorney docket number 58758-8001.US03, which is incorporated herein by reference in its entirety.

A timeline presentation dynamically displays events, annotations, and nested timelines in a pre-determined sequence. For example, a timeline presentation may step through each event, annotation, and nested timeline chronologically, presenting each element so a viewer may see additional information and, in some cases, displaying a multimedia file associated with an element. Multiple presentations can be created and saved for a given timeline, each having a unique set of attributes that drives its behavior. For example, one timeline presentation can be created for a professional audience, while another presentation of the same timeline may be created for a layperson audience. The disclosed system also allows a presenter to “markup” a timeline presentation to draw a viewer's attention to certain features and save these markups so that they can be displayed during subsequent presentations.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

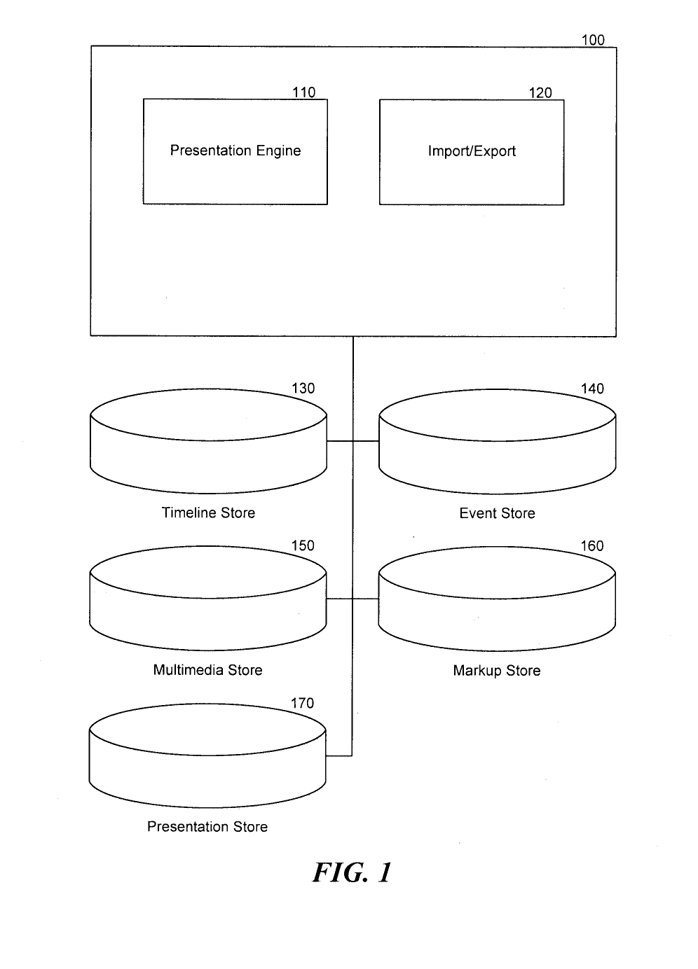

FIG. 1 is a block diagram of a system that allows a user to create and display a timeline presentation. A timeline is a graphical representation of a number of events that shows the relationship of the events to a particular time scale. Timelines are nested in the sense that two or more timelines are linked so that a user viewing one timeline may easily expand a portion of that timeline to view a related timeline. The system 100 includes a presentation engine 110 that interprets timelines and generates timeline presentations and an import/export component 120 that allows timeline presentations to be exported or imported to other applications or systems. The system is coupled to one or more data stores that contain the data for the construction and display of a timeline presentation. The data stores may include a timeline store 130 that stores timeline data structures, an event store 140 that stores event data structures, a multimedia store 150 that stores multimedia files (i.e., files containing one or more of audio, video, text, images), a markup store 160 that stores markup data structures, and a presentation store 170 that stores timeline presentation data structures. In some embodiments, event data structures are embedded in timeline data structures. In some embodiments, timeline data structures contain references to event data structures. When a multimedia media file is associated with a timeline or event, the multimedia file may be embedded into a timeline or into an event data structure. The data stores may be located proximate to the system or one of the data stores may be located remote from the system and accessed via a public or private network.

The system may be implemented in a computing device having a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the timeline system. Embodiments of the system may be implemented in and used with various operating environments that include personal computers, server computers, hand-held or laptop devices, multiprocessor systems, microprocessor-based systems, programmable consumer electronics, network PCs, computing environments that include any of the above systems or devices, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

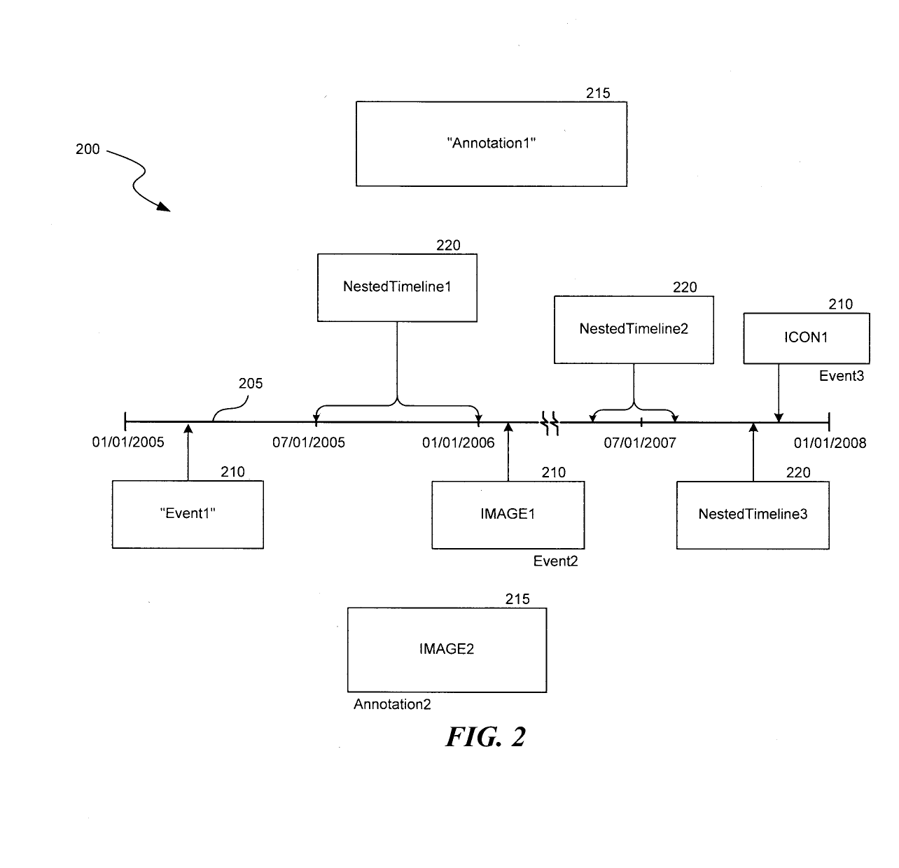

FIG. 2 is a display of a representative timeline 200 for which the disclosed system may generate a timeline presentation. The timeline consists of a timescale 205, events 210, annotations 215, and nested timeline identifiers 220. The timescale 205 is a graphical representation of a collection of time or dates. For example, in FIG. 2 the timescale is represented as a horizontal line across the page with five dates displayed along the line (e.g., “Jul. 1, 2005”). The timescale may be represented as a vertical bar, curved line, or any other graphical representation linking times or dates. The timescale typically includes date and time information so that a viewer can understand the relative progression of events. The system operator may specify which points in time are displayed in the timeline or the number of points in time that are displayed.

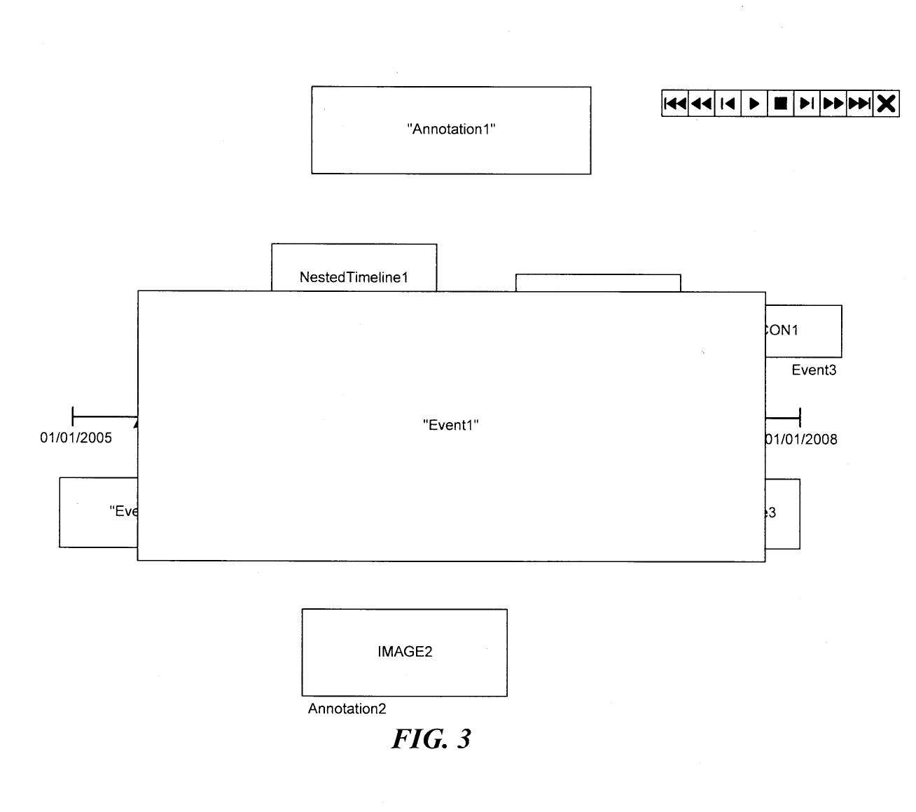

In some embodiments, a timeline presentation may begin by displaying a timeline in its entirety. The presentation may then progress through the timeline chronologically, dynamically presenting each element of the timeline. Events may be visually represented in a variety of different treatments. For example, a video event may be represented by an individual frame from a multimedia file associated with the video event. The frame may be selected automatically, for example by a default setting or user preference to select the starting frame or ending frame to visually represent the event. Alternatively, the user may select the frame manually, for example by pausing a video at the desired frame and selecting an option to associate the selected frame with the event. FIG. 3 is a display showing the presentation of a single timeline element. In this example, the first element in the timeline, Event1, has been magnified, or zoomed, and displayed in the center of the screen. The magnification focuses a viewer's attention to the event and gives the presenter an opportunity to display additional information associated with the event for which there may not have been room in the display of the entire timeline. Furthermore, when an event or annotation is displayed, a multimedia file associated with the element may also be presented. For example, the disclosed system may play an audio or video clip or display a document before, after, or concurrently with the magnification of the event. The system may play a multimedia file using an embedded media player, or may launch a separate application to play a multimedia file. Once the presentation of one element is complete, the timeline presentation transitions to the next element. Any multimedia file played with, or in association with, the presentation of an element may be closed, hidden, or left open for further viewing when the timeline presentation transitions to the next element. A timeline presentation may be timed so that it automatically transitions to the next element after a predetermined amount of time. In some cases, a timeline presentation may be untimed, enabling a presenter to cause the presentation to transition to the next element when desired by, for example, pressing a key on a keyboard or clicking a mouse button.

In this example, the next element to be presented is a nested timeline, NestedTimeline1. The presentation of a nested timeline may include displaying the nested timeline in its entirety either as an inset to its parent or completely replacing the display of its parent. The presentation of a nested timeline may also include presenting each element of the nested timeline in the manner described above. Once each element of a nested timeline has been presented, the presentation may return to presenting its parent timeline. A timeline presentation continues in this manner until each element of the associated timelines has been presented. In some embodiments, the nested timeline may be treated as a single event by the system, and the system may display a representation of the nested timeline before continuing to display the other elements in the parent timeline. In some embodiments, the nested timeline may be expanded by the system and each element in the nested timeline displayed until returning to the display of the parent timeline.

In some embodiments, an animation may accompany the presentation of an event, an annotation, or a nested timeline or the transition between the presentations of each element. For example, the system may “zoom in” on an event so that an event slowly expands until it fills the screen for display. When transitioning to the next event, the system would then “zoom out” on an event so that an event slowly contracts until it returns to its original size. Such zooming functionality is similar in concept to visual aspects of the Dock interface provided in Mac OS X. In some embodiments, a set of tools for manipulating the presentation are displayed with the presentation. FIG. 3 includes a display of a set of controls that allow a presenter to, for example, stop the presentation, go back to a previous element, skip ahead to an element, pause the presentation, start the presentation, or display or hide a set of markup tools.

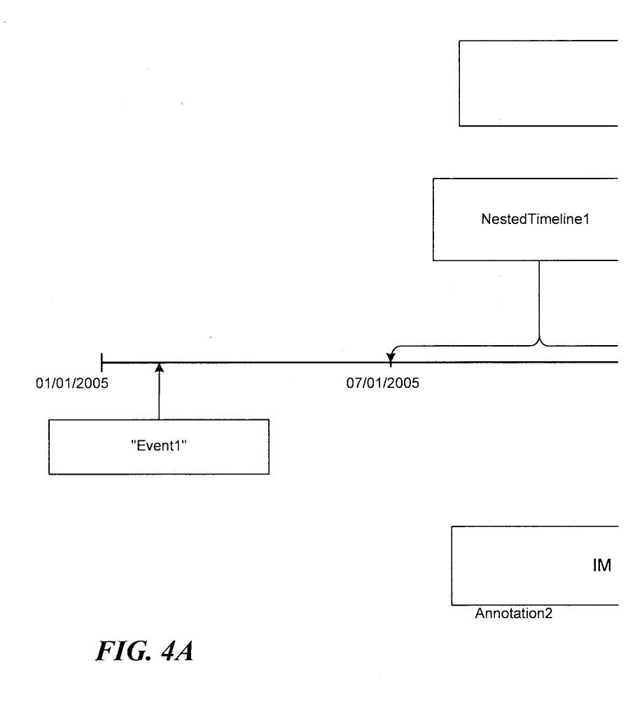

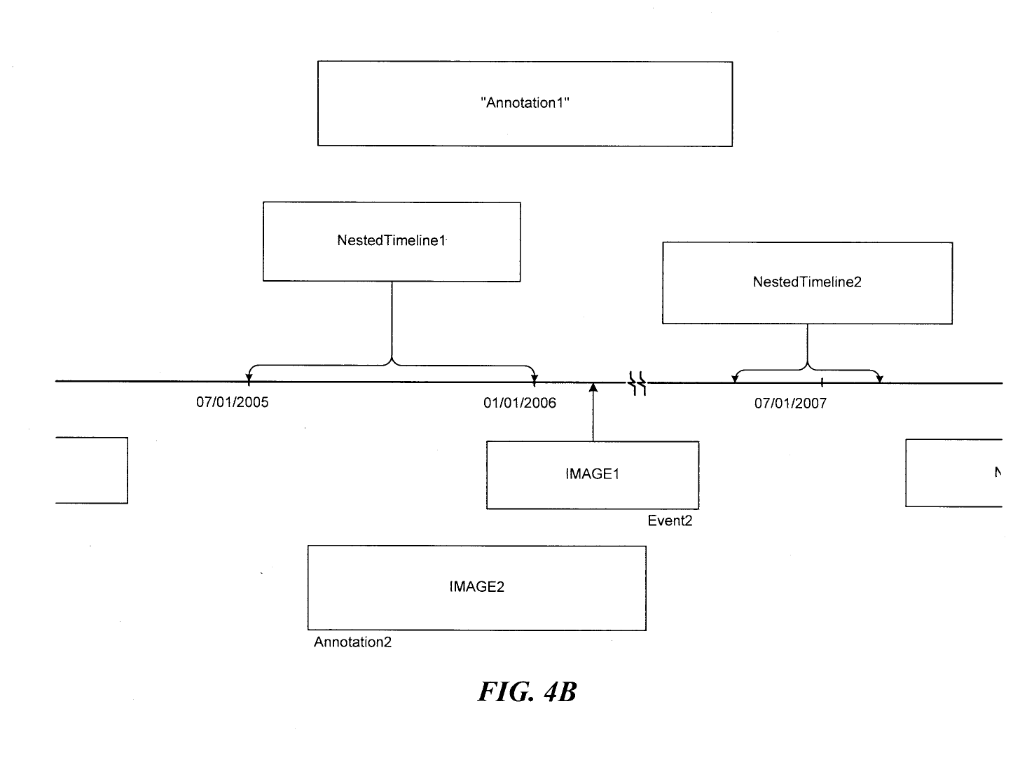

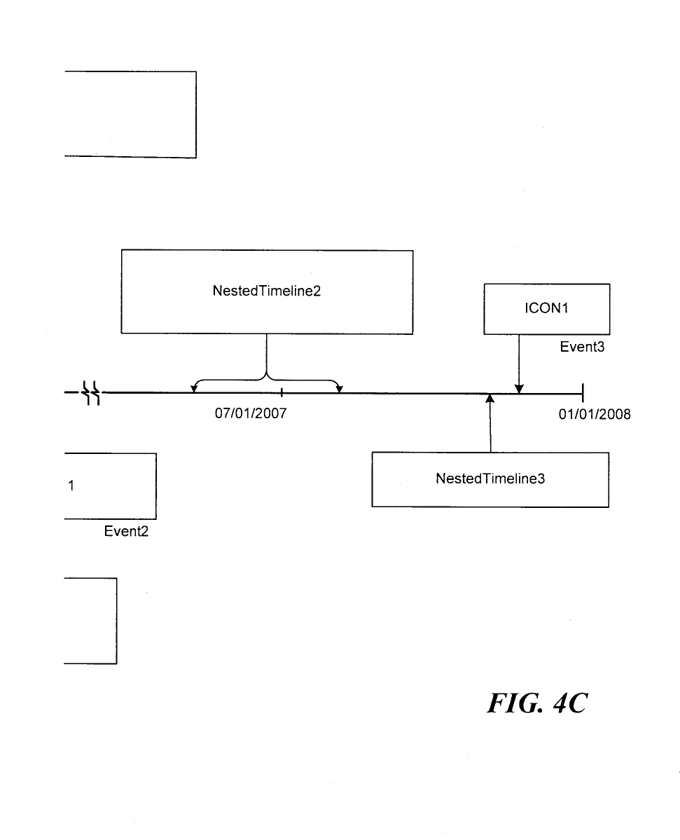

The disclosed system is capable of scrolling along a timeline during a presentation to display portions of a timeline from the start of the timeline to the finish of the timeline. The scrolling is particularly beneficial when the timeline does not fit on a single screen, such as when the timeline covers an extended period or when a presenter has enlarged a timeline to focus on particular events or details in the timeline. FIGS. 4A-4C each represent a display that would be presented by the system to an audience, each display showing a different portion of a timeline as the timeline is scrolled during a timeline presentation. In this example, the timeline presentation begins with FIG. 4A, transitions through FIG. 4B, and ends with FIG. 4C. Although only three displays are depicted in FIGS. 4A-4C, it will be appreciated that a multitude of displays may be generated by the system as the system causes the timeline to scroll across the available display space. The disclosed system allows a user to adjust the rate at which the timeline scrolls during a presentation. For example, the system may automatically scroll the timeline at a constant rate from start to finish. Alternatively, the presentation may be manually scrolled by the presenter, with the presenter causing the timeline to scroll forward, backward, or pause, depending on controls that are selected by the presenter. The system may also be configured to scroll a fixed-width only after each of the visible elements has been presented, for example, after the display of an element to automatically scroll until the next element in the timeline is reached.

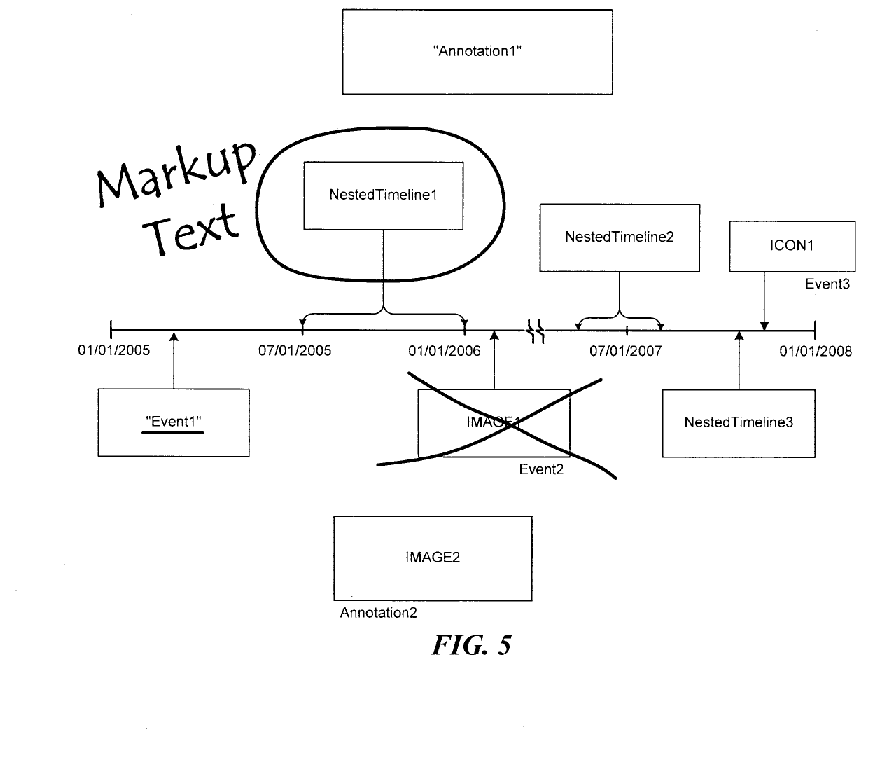

FIG. 5 is a timeline that has been marked up by a presenter during the course of a timeline presentation. In this example, the presenter has marked up the timeline of FIG. 2 by underlining text associated with Event1, circling NestedTimeline1, crossing out Event2, highlighting a portion of Annotation1, and adding text. To markup a timeline presentation, a presenter may first pause or suspend the presentation. Using the disclosed system, a presenter can markup a timeline presentation in any number of ways. The presenter may use a markup tool to add, for example, freehand or computer-assisted text, shapes, or lines to a presentation. In addition to marking up a timeline, a presenter may also markup a multimedia file associated with the timeline presentation. For example, if a video or image associated with an event were to be presented with the event, the presenter could highlight certain portions of the video or image by circling or underlining key elements. The markups may be persistent, or stored, so that they can be presented each time the timeline is presented or as a presenter moves forwards and backwards through the presentation. In some embodiments, the markups may be embedded into a timeline presentation data structure or an event data structure. In some embodiments, the markups may be stored in a markup data structure and displayed as a layer super-imposed over the timeline during a presentation. In some embodiments, a timeline may be marked up simultaneously by multiple presenters. One or more of the multiple presenters may be located proximate to the system, or one or more of the multiple presenters may be located remote from the system and access the system via a public or private network.

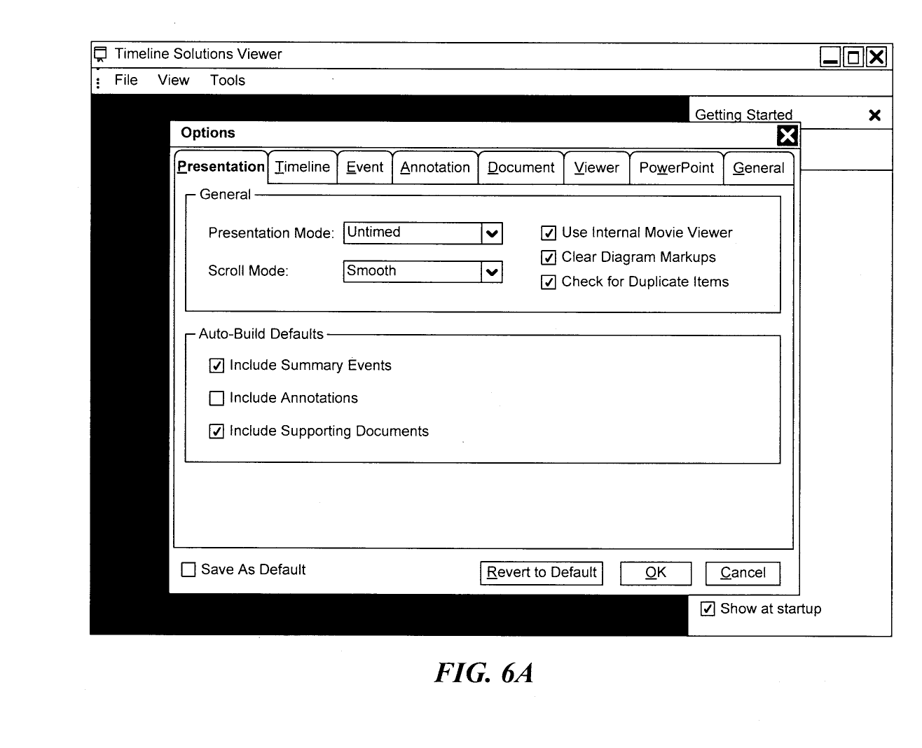

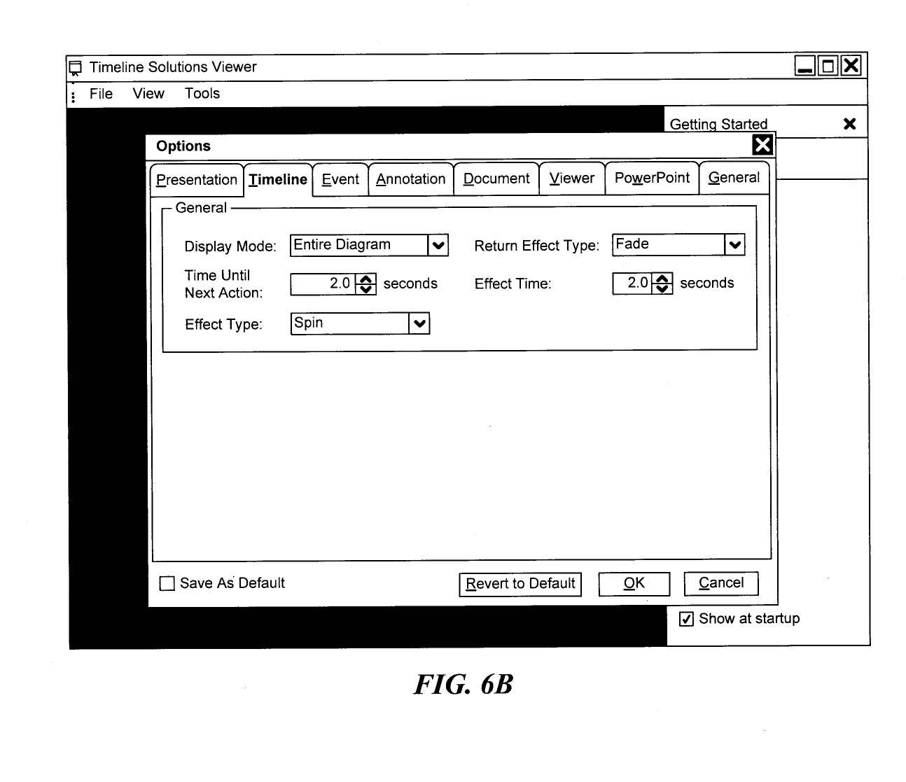

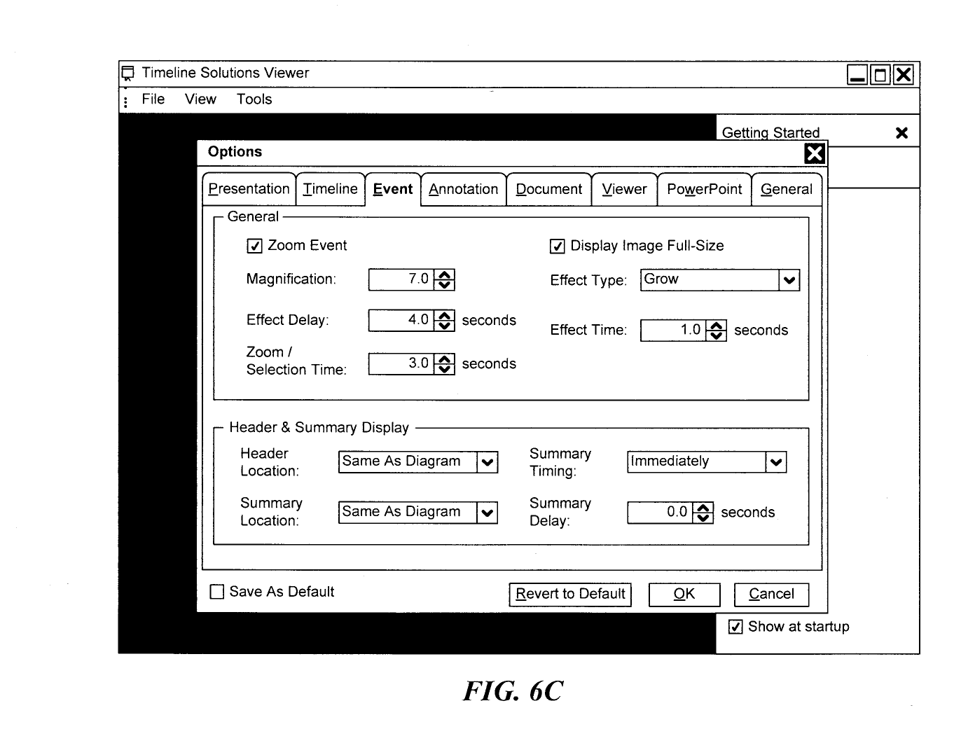

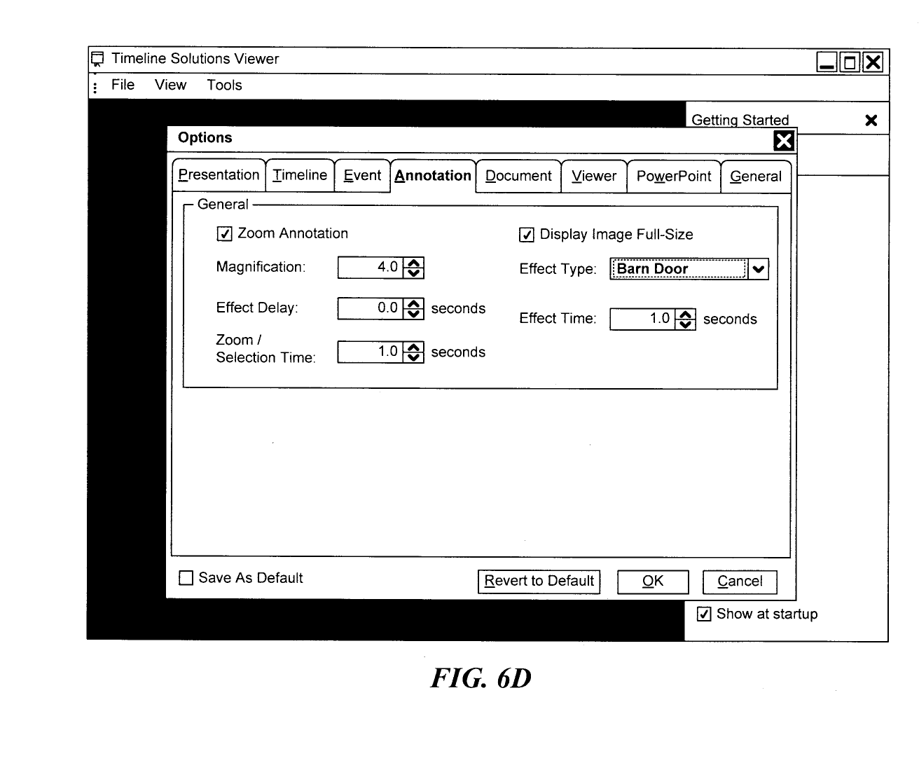

FIGS. 6A-6D show dialog box tabs that are generated by the system and that may be used by a presenter to customize a timeline presentation. FIG. 6A depicts a tab that a presenter may use to specify general options related to a timeline presentation, including settings for the timing and scrolling of a timeline during a presentation and the information to be included with the presentation. The “Presentation Mode” may be specified as either manual or timed. “Manual” allows a presenter to manually step through a timeline presentation, whereas “timed” allows a presenter to automatically step through a timeline presentation in a fashion where each event is shown for a predetermined time. The “Scroll Mode” may be specified as either smooth or half-page. “Smooth” means that the timeline will smoothly scroll across the field of view, while “half-page” means that the timeline will jump in half-page increments across the field of view. An “Auto-Build Defaults” section allows the presenter to specify the default elements that should be displayed in the timeline, prior to any mark-ups or other customization that is performed by the presenter.

FIG. 6B depicts a tab through which a presenter may specify options for displaying and transitioning to or from a timeline (i.e., to transition to and from a main timeline to a nested timeline or a timeline associated with a different party). The “Display Mode” may be set to show the entire timeline, show events on a per-party basis (i.e., Plaintiff first or Defendant first), or show events as they are encountered even if each party's events are displayed on separate timelines. The “Time Until Next Action” may be set to control the amount of time that elapses before the first timeline element is presented after transitioning to a timeline. The “Effect Type,” which may be spin, vertical slide, barn door, etc., controls the visual effect that is applied by the system when the presentation transitions to a timeline. For example, if the “spin” option is selected, when the presenter selects a nested timeline for display the nested timeline will expand for display while at the same time spinning to generate an interesting transition. The “Return Effect Type” controls the visual effect used by the system when the presenter returns from displaying a timeline, such as when returning to the main timeline. The “Effect Time” allows the presenter to specify the length of time that the transition effect is used by the system before displaying the timeline that is being transitioned to in static form.

FIG. 6C depicts a tab used by a presenter to specify options pertaining to the presentation of an event during a timeline presentation, as well as the type of event information to be included with a presentation. For example, the system allows an event to be zoomed when it is selected until it occupies a majority of the display (see, e.g., FIG. 3). The “General” region in FIG. 6C allows the presenter to specify various characteristics of the magnification, including the ultimate magnification amount (expressed as a multiple of the initial event size), the delay in seconds before the magnification begins, and the duration that the event is displayed by the system at the ultimate level of magnification. The “General” region also allows the presenter to specify a visual effect that will accompany the magnification. The presenter may specify the effect type (such as “grow,” “spin,” “fade,” etc.) as well as the duration of the visual effect in seconds. The “Header & Summary Display” region in FIG. 6C allows the presenter to specify where header and summaries may be placed with respect to the corresponding event that is associated with each header and summary.

FIG. 6D shows a tab used by a presenter to specify options pertaining to the presentation of an annotation during a timeline presentation. The “General” region in FIG. 6D allows the presenter to specify various characteristics of the magnification of the annotation, including the ultimate magnification amount (expressed as a multiple of the initial event size), the delay in seconds before the magnification begins, and the duration that the annotation is displayed by the system at the ultimate level of magnification. The “General” region also allows the presenter to specify a visual effect that will accompany the magnification. The presenter may specify the effect type (such as “grow,” “spin,” “fade,” etc.) as well as the duration of the visual effect in seconds.

Those skilled in the art will appreciate that the dialog box tabs that are generated by the system and depicted in FIGS. 6A-6D may include a greater or lesser number of options than those that are shown. By providing a large number of options, however, the system offers a significant amount of flexibility to presenters to create a timeline presentation that is optimized for the particular audience to which the timeline is being presented.

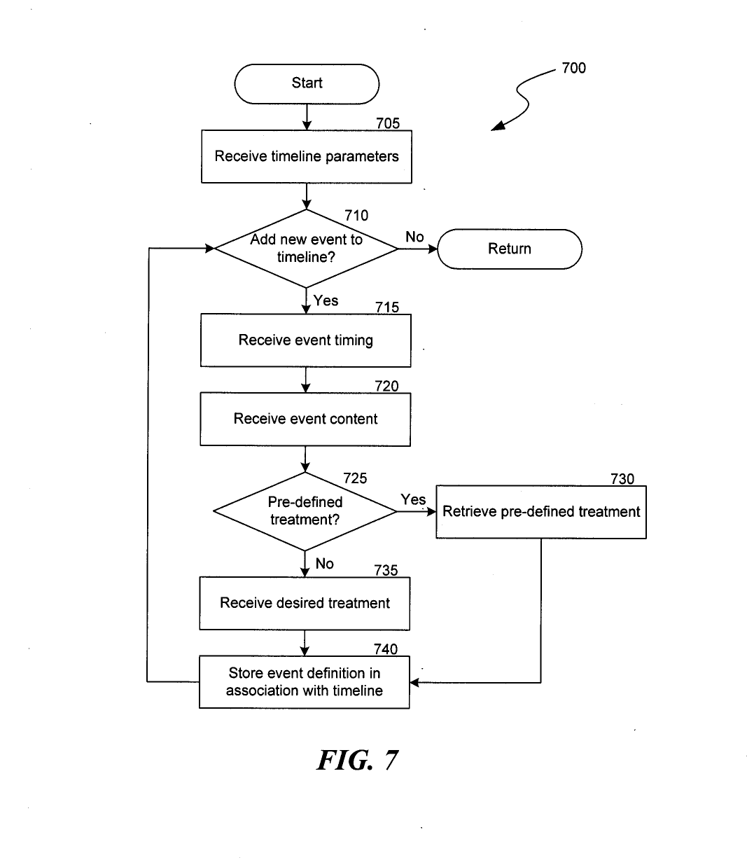

FIG. 7 is a flow chart of a process 700 for receiving an event definition from a user and storing the event definition in association with a timeline for subsequent presentation to a viewer. As previously noted, the system 100 stores timeline data structures in the timeline store 130, event data structures in the event store 140, and multimedia files (i.e., files containing one or more of audio, video, text, images) in the multimedia store 150. In some embodiments, a timeline is first created before receiving event definitions. At block 705, the system receives parameters from a user that define certain attributes of the timeline, such as the time period covered by the timeline (start time and end time) as well as the name, format, and background color of the timeline. In addition, the parameters may specify certain attributes related to events that subsequently will be placed on the timeline, such as the alignment of text associated with an event (e.g., left, center, or right alignment), the format of dates associated with an event (e.g., short format Sep. 1, 2004; fixed format Sep. 1, 2004; abbreviated format Sep. 1, 2004; or long format Sep. 1, 2004), or the format of times associated with an event (e.g., standard time 1:00 PM; military time 13:00; or no time displayed). Additional parameters may include specifying whether the day of the week is displayed with a date (e.g., Sep. 1, 2004 or Wed, Sep. 1, 2004), whether a year is displayed with a date (e.g., 9/1 or Sep. 1, 2004), and in cases where the year is displayed, whether a two-digit year or a four-digit year is displayed (e.g., Sep. 1, 2004 or Sep. 1, 2004).

After the timeline parameters have been set, at a decision block 710 the system determines whether an indication has been received from a user that an event is to be added to the timeline. If no additional events are to be added, processing halts. If an indication is received to add an event, processing continues to a block 715. At block 715, the system receives a time for the new event. The received time may be a discrete time, for example a particular calendar date or time of day for the new event. The received time may also be a time range, for example a start date and time of the new event and an end date and time for the event. The received time may also include an indication of whether the times and dates indicated are known precisely or are estimated. At block 720, the system receives the content for the event from a user, including, for example, header information (e.g., a title or location of the new event), summary information that may describe the new event, and any details of the new event. The content may include a multimedia file that is used to visually represent the event on the timeline, such as a picture, video, sound file, etc. The user may input the content directly (e.g., by keying the content), by providing a link to the content, or by uploading or providing a file that contains the content. Treatments may be assigned to the new event before it is associated with the timeline. For example, treatments may be assigned that dictate the shape associated with the event on the timeline, the color or size of the event on the timeline, the font used to render text on the event, or similar formatting features. At a decision block 725, the system determines whether a pre-determined treatment is to be assigned to the received event (e.g., when a user has specified that a template or common treatment is to be applied across all events). If the treatment that is associated with a new event is pre-defined, the identified treatment is associated with the event by the system at a block 730. Alternatively, a user may opt to assign a different treatment to a new event. If a pre-defined treatment is not applied, processing continues to a block 735 where the system receives details of the desired treatment from the user. After the treatments are received (whether by pre-defined application or by specified desired treatments), the system stores the timing, content, and treatment information as an event definition that is associated with the timeline at a block 740. One or more additional new events may be added to the timeline by repeating the process beginning at block 710.

It will be appreciated that a similar process to that described with respect to FIG. 7 may be used to store annotations in association with a timeline. Additionally, mark-ups, as they are received, may be stored in association with the timeline for subsequent re-display during presentation fo the timeline.

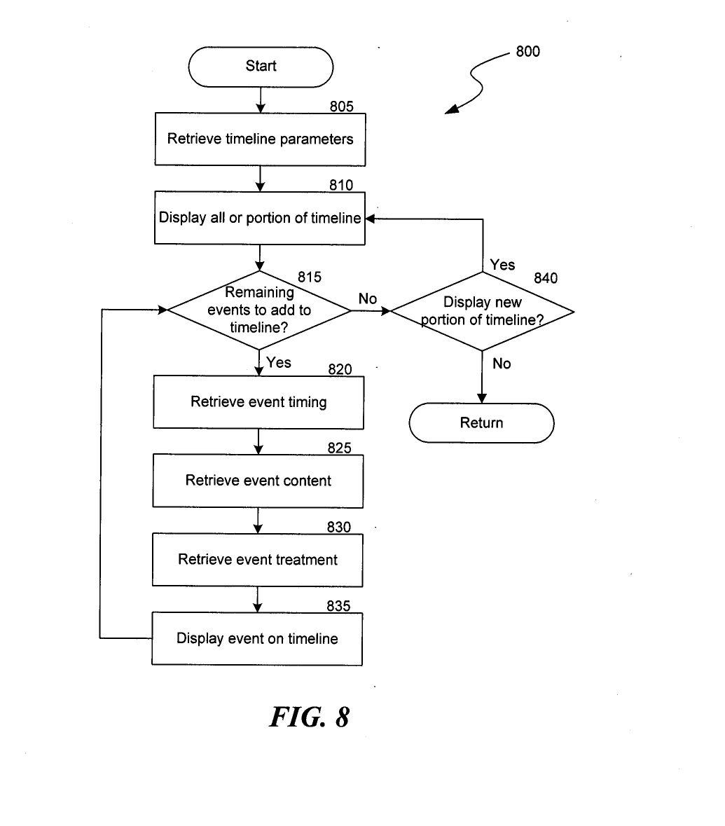

FIG. 8 is a flow chart of a process 800 for retrieving stored event definitions that are associated with a timeline and displaying the events as part of a timeline presentation. As previously noted, the system 100 includes a presentation engine 110 that interprets timelines and generates timeline presentations and an import/export component 120 that allows timeline presentations to be exported or imported to other applications or systems. At block 805, the system retrieves timeline parameters including, for example, the name and background color of the timeline, as well as certain parameters that may be used to display events on the timeline, including for example the text alignment, date format, and time format that should be used on the timeline. At block 810, the system uses the retrieved parameters to display all or a portion of the timeline that is to be populated with individual events. Only a portion of the timeline may be displayed, when, for example, the timeline is being scrolled as depicted in FIGS. 4A-4C. The system may display the timeline before overlaying the timeline with events, or may concurrently build and display the timeline and events. At a decision block 815, the system determines whether events remain to be added to timeline. If the system determines at block 815 that an event should be displayed on the timeline, the system retrieves the timing of the event at a block 820. As previously discussed, the timing of the event may include the event start date and time, an optional end date and time, and an indication of whether the times and dates indicated are known precisely or are estimated. At a block 825, the system retrieves the content associated with the event. As previously discussed, the content may include header information, such as a title or location of the event or summary information that describes the event or includes any details pertaining to the event. The content may be contained in or include a multimedia file that is used to visually represent the event on the timeline. At a block 830, the system retrieves the treatment associated with the event. As previously discussed, the event treatment may include the shape associated with the event, the color or size of the event on the timeline, the font used to render text on the event, or other formatting conventions for the event. The event timing, event content, and event treatment retrieved in blocks 820-830 are typically stored in the event definition, although in some embodiments an event treatment may be separately defined and applied by the system when constructing a timeline presentation. At a block 835, the system uses the retrieved event timing, event content, and event treatment to display the event during a timeline presentation.

New events may be added to the timeline for display by repeating the process beginning at decision block 815 until all desired events are presented on the portion of the displayed timeline. If no additional events need to be added to the timeline at decision block 815, processing continues to decision block 840. At decision block 840, the system determines whether a new portion of the timeline is to be displayed. A new portion may be displayed, for example, when a user is stepping through a timeline (see, e.g., the scrolling depicted in FIGS. 4A-4C) and has reached the end of a currently-displayed segment. In such a case, the system will then automatically display the adjacent segment of the timeline, either forward or backward in time or other dimension. As another example, a new portion may be displayed when a user selects a different portion of a timeline to view. The new portion may be selected by clicking on (or otherwise selecting) a different portion of the timeline. If the system determines that a new portion of the timeline is to be displayed, processing continues to block 810. Otherwise, the process halts.

From the foregoing, it will be appreciated that specific embodiments of the invention have been described herein for purposes of illustration, but that various modifications may be made without deviating from the scope of the invention. Those skilled in the art will appreciate that the depicted flow charts may be altered in a variety of ways. For example, the order of the steps may be rearranged, steps may be performed in parallel, steps may be omitted, or other steps may be included. Accordingly, the invention is not limited except as by the appended claims.

1. A computer-implemented method of displaying a timeline presentation that contains a plurality of events, the method comprising:
retrieving a plurality of event definitions that are associated with a timeline, each of the event definitions comprising:
a time on the timeline that is associated with an event;
content associated with the event; and
a visual treatment of the event;
identifying a first portion of the timeline to display to a viewer;
identifying a first set of one or more event definitions that are associated with the first portion of the timeline to display;
displaying events on the first portion of the timeline based on the identified first set of event definitions; and
in response to receiving an indication to display another portion of the timeline:
identifying a second portion of the timeline to display to the viewer;
identifying a second set of one or more event definitions that are associated with the second portion of the timeline to display; and
displaying events on the second portion of the timeline based on the identified second set of event definitions.

2. The computer-implemented method of claim 1, wherein the indication to display another portion of the timeline is received from a viewer.

3. The computer-implemented method of claim 1, wherein the indication to display another portion of the timeline is automatically generated based on a predetermined condition.

4. The computer-implemented method of claim 1, wherein the second portion of the timeline is identified based on a predetermined width from the first portion of the timeline.

5. The computer-implemented method of claim 1, wherein the second portion of the timeline is identified based on a temporal relationship between one or more events displayed on the first portion of the timeline and one or more events not displayed on the first portion of the timeline.

6. The computer-implemented method of claim 1, wherein one or more events displayed on the timeline are visually represented as a photograph, a video file, or a selected frame of a video file.

7. The computer-implemented method of claim 6, wherein the selected frame of a video file is selected by the viewer.

8. The computer-implemented method of claim 6, wherein the selected frame of a video file is selected automatically.

9. The computer-implemented method of claim 1, further comprising:
receiving one or more markups to the displayed portion of the timeline; and
displaying the one or more markups on the timeline.

10. The computer-implemented method of claim 9, wherein the received markups comprise freehand shapes, highlighting, or alphanumeric text.

11. The computer-implemented method of claim 9, wherein the markups are received from multiple viewers of the timeline presentation.

12. The computer-implemented method of claim 9, wherein the markups are electronically stored and presented in a subsequent display of the timeline presentation.

13. A computing system configured to display a timeline presentation that contains a plurality of events, comprising:
an event storage area that stores a plurality of event definitions that are associated with a timeline;
a memory storing computer-executable instructions of a presentation engine configured to:
retrieve a plurality of event definitions that are associated with a timeline from the event storage area, each of the event definitions comprising a time on the timeline that is associated with the event, content associated with the event, and a visual treatment of the event;
identify a first portion of the timeline to display to a viewer;
identify a first set of one or more event definitions that are associated with the first portion of the timeline display;
display events on the first portion of the timeline based on the identified first set of event definitions; and
in response to receiving an indication to display another portion of the timeline, identify a second portion of the timeline to display to the viewer, identify a second set of one or more event definitions that are associated with the second portion of the timeline from the event storage area to display, and display events on the second portion of the timeline based on the identified second set of event definitions; and
a processor for executing the computer-executable instructions stored in the memory.

14. The computing system of claim 13, wherein the indication to display another portion of the timeline is received from a viewer.

15. The computing system of claim 13, wherein the indication to display another portion of the timeline is automatically generated based on a predetermined condition.

16. The computing system of claim 13, wherein the presentation engine is configured to identify the second portion of the timeline based on a predetermined width from the first portion of the timeline.

17. The computing system of claim 13, wherein the presentation engine is configured to identify the second portion of the timeline based on a temporal relationship between one or more events displayed on the first portion of the timeline and one or more events not displayed on the first portion of the timeline.

18. The computing system of claim 13, wherein the one or more events displayed on the timeline are visually represented as a photograph, a video file, or a selected frame of a video file.

19. The computing system of claim 18, wherein the presentation engine further configured to allow the selected frame of a video file to be selected by the viewer.

20. The computing system of claim 18, wherein the presentation engine further configured automatically select the selected frame of a video file.

21. The computing system of claim 13, wherein the presentation engine is further configured to receive one or more markups to the displayed portion of the timeline.

22. The computing system of claim 21, wherein the received markups comprise freehand shapes, highlighting, or alphanumeric text.

23. The computing system of claim 21, wherein the markups are received from multiple viewers of the timeline presentation.

24. The computing system of claim 21, wherein presentation engine is further configured to store the markups for subsequent display with the timeline presentation.
